(19) United States
(12) Patent Application Publication
(10) Pub. No.: US 2025/0109828 A1
(43) Pub. Date: Apr. 3, 2025

(54) SWINGING TOOL HOLDER

(71) Applicant: SAUDI ARABIAN OIL COMPANY, Dhahran (SA)

(72) Inventors: Pravinkumar Patil, Udhailiyah (SA); Zakaria Musa, Udhailiyah (SA); Jamal H. Khalaifa, Al Mubarraz (SA); Abdulrahman Takrouni, Al Mubarraz (SA)

(73) Assignee: SAUDI ARABIAN OIL COMPANY, Dhahran (SA)

(21) Appl. No.: 18/477,148

(22) Filed: Sep. 28, 2023

(51) Int. Cl. F17C 13/06; F16M 11/06; F16M 13/02

(52) U.S. Cl. CPC F17C 13/06; F16M 11/06; F16M 13/022; F16M 2200/065; F17C 2205/0379

(57) ABSTRACT

In general, in one aspect, embodiments disclosed herein relate to a system for supporting a tool in a manway. The system includes a tool holding device. The tool holding device includes a holder plate, a hinge attached to the holder plate, a holder arm attached to the hinge, a clamp attached to the holder arm, and a resting arm attached to the clamp. The holder plate includes a first connector. The hinge permits swinging the tool holding device into and out of a manway. A second connector is included on the manway to be compatible with the first connector.

### BACKGROUND

It is common in many industrial situations to have a manway in which a tool such as an air mover or light needs to be supported. In many such situations, placing the tool on the floor or on a floor mounted support poses additional complications, such as the tool being a tripping hazard, the tool or tool mount damaging the floor, negative effects on the coverage area of the tool, etc.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a system for supporting a tool in a manway. The system includes a tool holding device. The tool holding device includes a holder plate, a hinge attached to the holder plate, a holder arm attached to the hinge, a clamp attached to the holder arm, and a resting arm attached to the clamp. The holder plate includes a first connector. The hinge permits swinging the tool holding device into and out of a manway. A second connector is included on the manway to be compatible with the first connector.

In general, in one aspect, embodiments disclosed herein relate to a system for supporting a tool in a manway. The system includes a tool holding device. The tool holding device includes multiple resting arms, and a clamp attached to the resting arms. The resting arms are positioned radially around the clamp and reach across the manway.

In general, in one aspect, embodiments disclosed herein relate to a method for using a tool holding device to support a tool in a manway. The tool holding device includes a holder plate, a hinge attached to the holder plate, a holder arm attached to the hinge, a clamp attached to the holder arm, and a resting arm attached to the clamp. The holder plate includes a first connector. The hinge permits swinging the tool holding device into and out of a manway. A second connector is included on the manway to be compatible with the first connector. The method includes attaching the holder plate of the tool holding device to an edge of the manway and clamping the tool in the clamp.

Other aspects and advantages of the claimed subject matter will be apparent from the following description and the appended claims.

### BRIEF DESCRIPTION OF DRAWINGS

FIG. 1 shows a tool holding device in accordance with one or more embodiments.

FIG. 2 shows a tool holding device in accordance with one or more embodiments.

FIG. 3 shows a manway in accordance with one or more embodiments.

FIG. 4 shows a tool holding device in accordance with one or more embodiments.

### DETAILED DESCRIPTION

In one aspect, embodiments disclosed herein relate to a system for supporting a tool within a manway by providing a clamp mounted to an edge of the manway. As used herein, the term “manway” refers to an opening or passage designed to allow a person to traverse from one space to another space. For example, the space may be a confined space, such as a tank or vessel, and the manway allows entry and exit of personnel into and out of the confined space. In such situations, it is often necessary to provide fresh air to the confined space for the safety of anyone working inside. However, when tools, like an air mover, lights, or the like, are positioned in the manway, it may be difficult to enter or exit the manway. Accordingly, embodiments disclosed herein include features that permit such tools to be quickly moved out of the path of the manway. Additionally, the tool may be held be the clamp between a central location in the manway and swung fully clear of the manway.

Embodiments of the present disclosure may provide at least one of the following advantages. The ability to swing a mounted tool out of a manway provides unrestricted entrance and egress through a manway. Also, the ability of the device to hold a tool, such as a conical air mover, centrally within a manway can provide increased coverage for the effect of the tool compared to that same tool being mounted or disposed on an edge surface. Mounting a tool to an exterior surface of a vessel, as opposed to the floor of said vessel can minimize surface damage within the vessel.

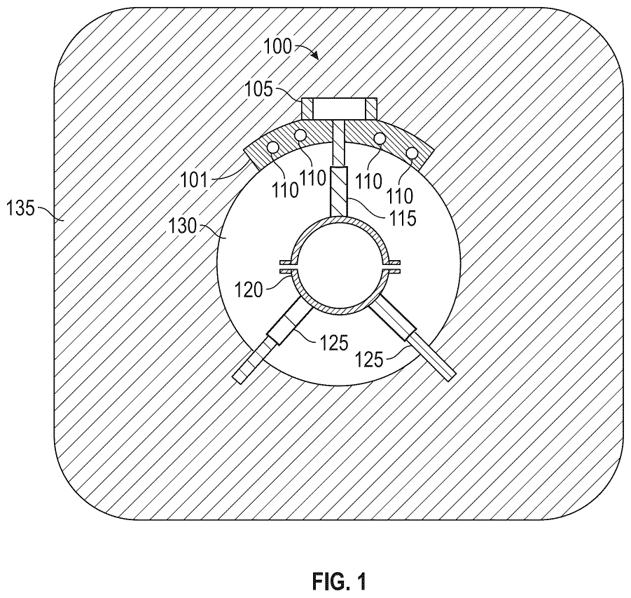

FIG. 1 shows a tool holding device in accordance with one or more embodiments. FIG. 1 is a front view of a tool holding device 100. The tool holding device 100 in one or more embodiments comprises a holder plate 101, a hinge 105, a first connector 110, a holder arm 115, a clamp 120, and two resting arms 125 arranged as shown with the holder arm 115 and resting arms 125 positioned radially around the clamp 120. The clamp 120 may facilitate supporting a tool, such as a light or a conical air mover. A conical air mover is a pneumatically powered tool that may serve to move large volumes of air via the venturi effect using a large cone.

The first connector 110 may serve to allow the tool holding device to be connected to a surface 135 in which a manway 130 exists. Thus, a tool may be held in position in the manway. To provide additional support and stabilization, the resting arms 125 may comprise magnets that interact with ferromagnetic materials that may be present in the surface surrounding the manway 130. The one or more resting arms 125 may be telescopically extendable to span a variable size of manway, allowing the tool holding device to be used for a variety of manways. The holder arm 115 may also be telescopically extendable to reach at least from an edge to a middle of the manway. In one or more embodiments, the tool holding device may be made of a “safety material,” i.e., a material that is non-sparking, durable, and/or lightweight so as to improve the safety factor of the device.

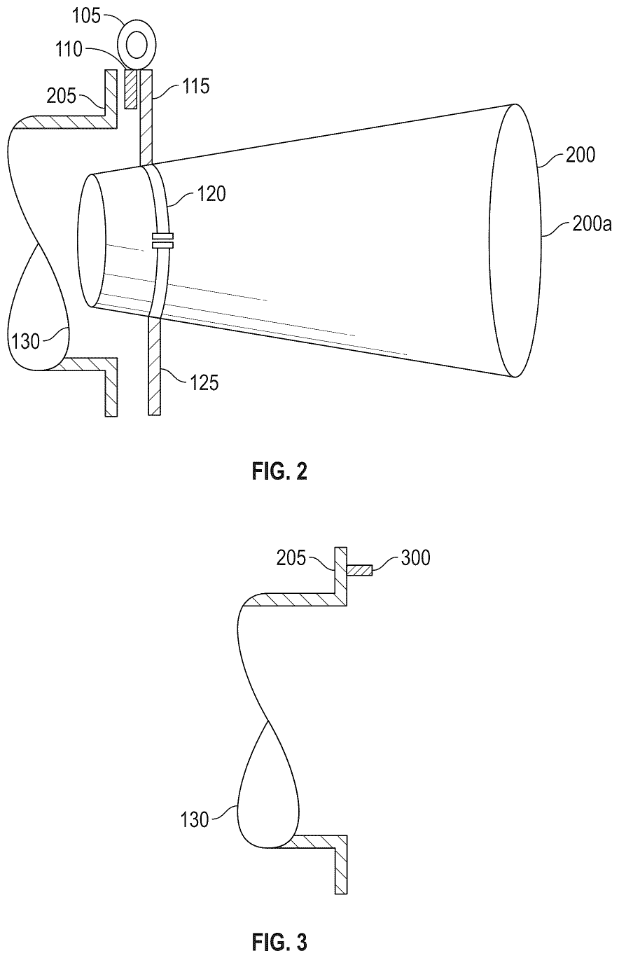

FIG. 2 shows a tool holding device in accordance with one or more embodiments. FIG. 2 is a side view of the tool holding device 100 holding a tool 200. In one or more embodiments, the tool 200 is a conical air mover. In one or more embodiments, the surface that the manway 130 is through comprises a flange 205 to which comprises a second connector (not shown) that the first connector 110 attaches. Further, the magnets of the first connector 110 and/or of the resting arms 125 may be switchable magnets.

FIG. 3 shows a manway in accordance with one or more embodiments. FIG. 3 is a side view of a manway 130 showing the second connector 300 arranged on the flange 205. The second connector 300 may comprise bolts compatible with bolt holes of the first connector 110. The second connector 300 may also or instead comprise a ferromagnetic material that is attracted to magnets comprised in the first connector 110.

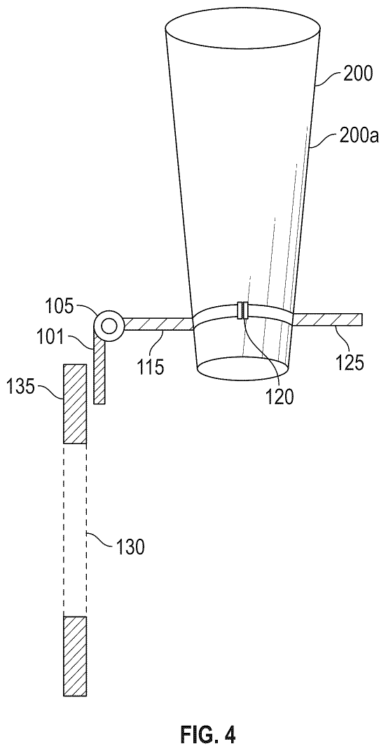

FIG. 4 shows a tool holding device in accordance with one or more embodiments. FIG. 4 is a side view of the tool holding device 100 depicted in FIG. 2, showing an additional function of being able to rotate the tool holding device 100 and, thus, move a tool 200 fully clear of the manway 130.

The system described herein may also be used in a vertical manway, optionally without the hinge 105, first connector 110, holder plate 101, and/or holder arm. This configuration may rely on gravity to hold the tool holding device 100 in place in the manway 130. Those skilled in the art will also appreciate that latches or other locking mechanisms may also be included in order to maintain the tool at a particular position within or outside of the manway.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

1.-11. (canceled)

12. A
tool holding device comprising:
a clamp configured to hold a tool; and
a plurality of arms attached to and positioned radially around the clamp,
wherein at least one of the plurality of arms is extendable across a manway, and
wherein the plurality of arms comprises a holder arm and a resting arm.

13. The tool holding device of claim 12, wherein the clamp is adjustable in size.

14. The tool holding device of claim 12, wherein the resting arm is telescopically extendable.

15. The tool holding device of claim 12, wherein the tool holding device is made of a safety material.

16. A method for using a tool holding device to support a tool in a manway, wherein the tool holding device comprises:
a clamp configured to hold a tool,
a plurality of arms
attached to and positioned radially around the clamp, wherein at least one of the plurality of arms is extendable across a manway, and wherein the plurality of arms comprises a holder arm and a resting arm;
the method comprising:
resting the tool holding device against a surface adjacent to the manway, and
clamping the tool in the clamp.

17. The method of claim 16, further comprising telescopically extending the holder arm to position the tool in the manway.

18. (canceled)

19. The method of claim 16, further comprising telescopically extending the resting arm to stabilize the tool holding device against the surface.

20. (canceled)

21. The tool holding device of claim 12, wherein the holder arm is telescopically extendable.

22. The tool holding device of claim 12, wherein the tool comprises a conical air mover.

23. The tool holding device of claim 12, wherein a hinge is attached to the holder arm, and wherein the tool holding device is swingable using the hinge.

24. The tool holding device of claim 23, further comprising a holder plate attached to the hinge.

25. The tool holding device of claim 24, wherein the holder plate has a first connector.

26. The tool holding device of claim 25, further comprising a second connector mounted on a surface adjacent to the manway,
wherein the first connector and the second connector are connectable to each other.

27. The tool holding device of claim 26, wherein the first connector comprises a magnet and the second connector comprises a ferromagnetic material, and
wherein the first connector is configured to hold the holder plate in position against the second connector.

28. The tool holding device of claim 26, wherein the second connector comprises a bolt.

29. The tool holding device of claim 26, wherein the second connector comprises a flange on the surface.

30. The tool holding device of claim 12, wherein the resting arm comprises a magnet,
wherein the magnet is configured to detachably hold the resting arm against a surface adjacent to the manway, and
wherein the surface is made of a ferromagnetic material.

31. The tool holding device of claim 30, wherein the magnet comprises a switchable magnet.

32. The method of claim 16, further comprising attaching a hinge to the holder arm, wherein the tool holding device is swingable using the hinge.

33. The method of claim 32, further comprising swinging the tool holding device into and out of the manway.
